(19) United States
(12) Patent Application Publication
(10) Pub. No.: US 2015/0199185 A1
(43) Pub. Date: Jul. 16, 2015

(54) System and Method for Providing Online Software Development Services

(71) Applicants: David Saff, Arlington, MA (US); Will Phan, Dorchester, MA (US); Matt Vail, Dorchester, MA (US); Greg Dennis, Somerville, MA (US); Tayeb Karim, Somerville, MA (US)

(72) Inventors: David Saff, Arlington, MA (US); Will Phan, Dorchester, MA (US); Matt Vail, Dorchester, MA (US); Greg Dennis, Somerville, MA (US); Tayeb Karim, Somerville, MA (US)

(21) Appl. No.: 13/075,402

(22) Filed: Mar. 30, 2011

(51) Int. Cl. G06F 9/45; H04L 29/08; G06F 15/173

(52) U.S. Cl. CPC G06F 8/41; H04L 67/104

(57) ABSTRACT

Access to program code maintained by a first online service is provided to a user device. Access to the program code is provided to a second online service via a network, and information concerning a function performed by the second online service with respect to the program code is provided to the user device. In one embodiment, a selection of the second online service is received from the user device, and access to the program code is provided to the second online service in response to the selection. The function performed by the second online service may comprise a function not provided by the first online service.

### TECHNICAL FIELD

This specification relates generally to systems and methods for providing online services, and more particularly to systems and methods for providing online services in a software development environment.

### BACKGROUND

Online software development services are available to facilitate the creation of program code by software developers. Existing online software development services typically consist of an integrated suite of applications providing a predetermined set of functions and features, including tools for code generation, code analysis, error detection, etc. Developers can access an online software development service via a network such as the Internet and utilize the available functions and features. However, developers are limited to using only those functions and features provided by the current suite of applications. While a software development service may be updated from time to time by the administrator to include new or improved features and functions, performing such updates can be complex and costly.

### SUMMARY OF THE INVENTION

In accordance with an embodiment of the invention, a method for providing online services is provided. Access to program code maintained by a first online service is provided to a user device. Access to the program code is provided to a second online service via a network, and information concerning a function performed by the second online service with respect to the program code is provided to the user device. In one embodiment, a selection of the second online service is received from the user device, and access to the program code is provided to the second online service in response to the selection. The function performed by the second online service may comprise a function not provided by the first online service.

In some embodiments, the first online service comprises a cloud-based collaborative software development service. Accordingly, users of the first online service may access, generate and update program code. The program code is stored in a memory. Simultaneous access to the program code may be provided to the user device and to a second user device. In other embodiments, the first online service comprises a cloud-based software development service that does not enable multiple users to collaborate in developing program code.

The second online service may comprise a compiling service, and the function provided may comprise periodically compiling the program code. The second online service may comprise a testing service, and the function provided may comprise periodically testing the program code. In other embodiments, the second online service may comprise a code similarity identification service, a code review service, a lint checking service, a comment review service, an automatic code generation service, a code editing service, a code analysis service, an error detection and correction service, a debugging service, a code building service, a code deployment service, a code execution service, a code searching service, a version control service, etc.

The first online service may reside and operate on a first server connected to the network, and the second online service may reside and operate on a second server connected to the network.

In accordance with another embodiment of the invention, an apparatus is provided. The apparatus comprises means for providing to a user device access to program code maintained by a first online service, means for providing to a second online service access to the program code via a network, and means for providing to the user device information concerning a function performed by the second online service with respect to the program code.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to provide online services in accordance with an embodiment;

FIG. 2 shows functional components of an exemplary user device;

FIG. 3 shows functional components of a cloud-based collaborative software development service in accordance with an embodiment;

FIG. 4 shows a display of a program code file in accordance with an embodiment;

FIG. 5 is a flowchart of a method for providing online services in accordance with an embodiment;

FIG. 6 shows a display of a program code file and results of a compile operation in accordance with an embodiment;

FIG. 7 shows a display of a program code file and results of a test operation in accordance with an embodiment; and

FIG. 8 shows components of an exemplary computer.

### DETAILED DESCRIPTION

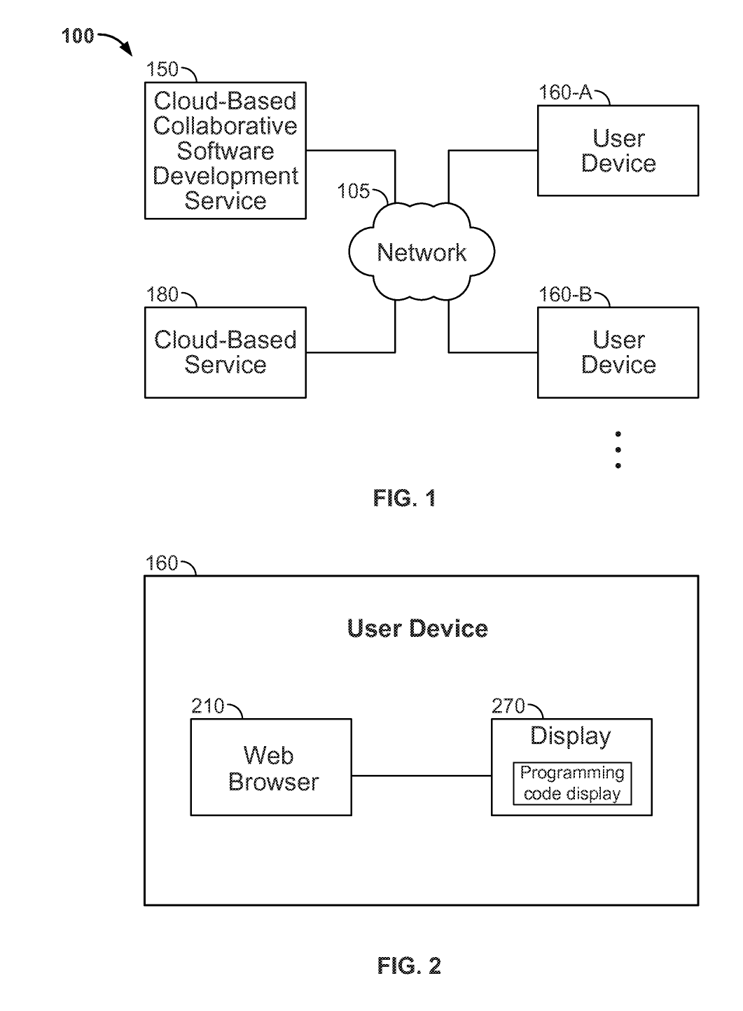

FIG. 1 shows a communication system 100 that may be used to provide online services, in accordance with an embodiment. Communication system 100 comprises a network 105, a cloud-based collaborative software development service 150, a cloud-based service 180, and user devices 160-A, 160-B, etc. For convenience, the term “user device 160” is used herein to refer to any one of user devices 160-A, 160-B, etc. Accordingly, any discussion herein referring to “user device 160” is equally applicable to each of user devices 160-A, 160-B, etc. Communication system 100 may comprise more or fewer than two user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

Cloud-based collaborative software development service 150 provides software development services to users via network 105, enabling users to write (or otherwise generate), edit, and display program code remotely. Cloud-based collaborative software development service 150 may allow multiple users to access a file containing program code simultaneously to collaboratively write and edit the program code. Cloud-based collaborative software development service 150 may be accessible via a World Wide Web page that may be viewed using a conventional Web browser, for example. A user may be required to log into a respective user account to utilize the services of cloud-based collaborative software development service 150. Cloud-based collaborative software development service 150 may offer common software development functions such as automatic code generation, code editing, code analysis, error detection and correction, debugging, code building, deployment, execution, searching, review, testing, version control, etc.

In other embodiments, a cloud-based software development service that provides software development services to users via network 105, enabling users to write (or otherwise generate), edit, and display program code remotely, but that does not enable multiple users to collaborate in developing program code, may be used.

User device 160 may be any device that enables a user to communicate via network 105. User device 160 may be connected to network 105 through a direct (wired) link, or wirelessly. User device 160 may have a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

FIG. 2 shows functional components of an exemplary user device 160. User device 160 comprises a web browser 210 and a display 270. Web browser 210 may be a conventional web browser used to access World Wide Web sites via the Internet, for example. Display 270 displays text, graphics, Web pages, and other information to a user. For example, a file containing programming code that a user creates or edits may be displayed on display 270.

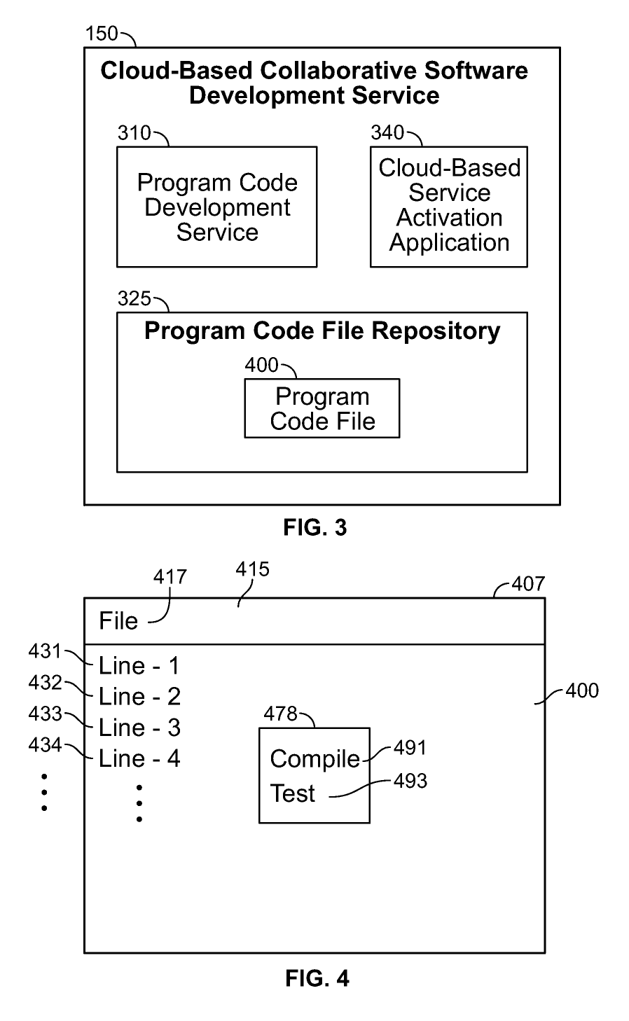

FIG. 3 shows functional components of cloud-based collaborative software development service 150 in accordance with an embodiment. Cloud-based collaborative software development service 150 comprises a program code development service 310, a cloud-based service activation application 340, and a program code file repository 325.

Program code development service 310 provides software development services to users. For example, program code development service 310 may enable a user to write program code, or to generate program code in another manner, such as by use of object-oriented software development tools. Program code development service 310 may also provide services relating to automatic code generation, code editing, code analysis, error detection and correction, debugging, code building, deployment, execution, searching, review, testing, version control, etc.

Cloud-based service activation application 340 provides access to other cloud-based services. When a user accessing program code maintained by cloud-based collaborative software development service 150 wishes to utilize a desired service or function provided by another cloud-based online service accessible via network 105, cloud-based service activation application 340 accesses the other cloud-based online service and activates the desired service or function. Cloud-based service activation application 340 may communicate with the other cloud-based service and provide to the other cloud-based service access to the user's program code, for example.

Program code file repository 325 comprises memory and/or storage. Program code development service 310 may store and maintain program code generated by a user within program code file repository 325. Other types of data may also be stored in program code file repository 325.

In accordance with the embodiment of FIG. 1, a user may access cloud-based collaborative software development service 150 and create and/or edit program code. For example, a user may employ browser 210 operating on user device 160-A to access a World Wide Web site maintained by cloud-based collaborative software development service 150. In a well-known manner, the user may be required to log into a user account to access his or her program code. The user may be required to authenticate his or her identity, e.g., by entering a user name and password, before accessing his or her user account and program code associated with the account.

Suppose, for example, that a user employs browser 210 operating on user device 160-A to access cloud-based collaborative software development service 150, and creates a program code file, such as program code file 400 illustrated in FIG. 4. In this example, the user utilizes code generation and code editing functions of cloud-based collaborative software development service 150 to produce lines of code 431, 432, 433, 434, etc., in program code file 400, as shown in FIG. 4. Cloud-based collaborative software development service 150 stores program code file 400 in program code file repository 325, as shown in FIG. 3. In other embodiments, cloud-based collaborative software development service 150 may provide other types of program code generation functions (such as an object oriented software development tool) to enable a user to generate program code. In other embodiments, program code generated by a user may be displayed or represented on display 270 in a manner different from that shown in FIG. 4.

To enable the user to view and edit program code file 400, cloud-based collaborative software development service 150 transmits data causing user device 160-A to display a representation of all or a portion of the program code on a Web page, in a well-known manner. For example, cloud-based collaborative software development service 150 may transmit to browser 210 a request, in the form of HyperText Markup Language (HTML), adapted to cause browser 210 to display a representation of program code file 400. In response, browser 210 displays a representation of all or a portion of program code file 400 in a window 407 on display 270. In the example of FIG. 4, browser 210 displays lines of code 431, 432, 433, 434, etc. Browser 210 also displays a toolbar 415 which may display various available options and/or functions available to the user, such as a file function 417. When the user edits and saves program code file 400, the updated program code file is stored in program code file repository 325.

Cloud-based collaborative software development service 150 allows multiple users to access program code simultaneously, in order to facilitate collaborative software development. For example, a first user employing user device 160-A, and a second user employing user device 160-B, may access program code file 400 simultaneously.

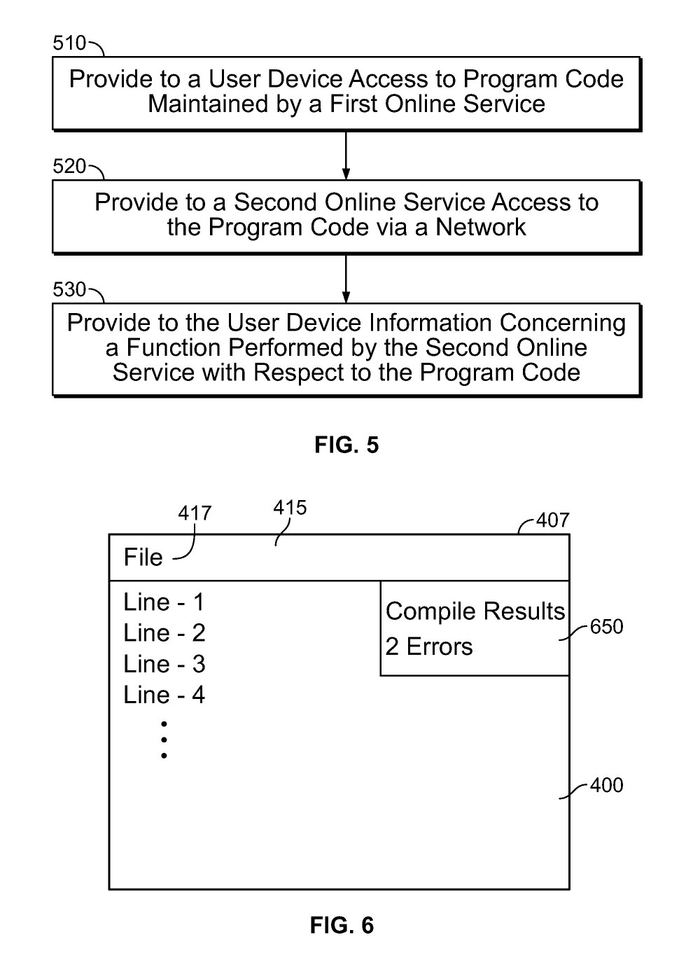

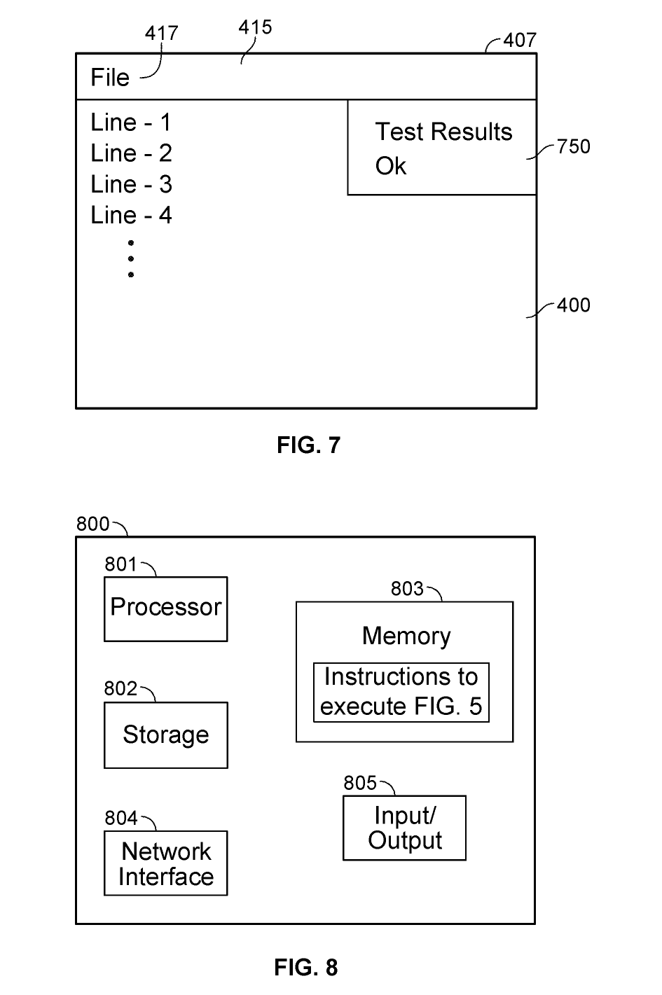

In accordance with an embodiment, a user accessing program code file 400 may activate a cloud-based online service that provides a desired service or function that is different from those provided by cloud-based collaborative software development service 150. For example, a user may activate cloud-based service 180. In response, the cloud-based online service 180 provides a desired function with respect to program code file 400. Cloud-based service 180 may reside and operate at a location (e.g., on a server) remote from cloud-based collaborative software development service 150, for example. In other embodiments, cloud-based service 180 may comprise a separate application that resides and operates at the same location (e.g., on the same server) as cloud-based collaborative software development service 150. Cloud-based service 180 and cloud-based collaborative software development service 150 may be maintained and operated by different entities. Alternatively, cloud-based service 180 and cloud-based collaborative software development service 150 may be maintained and operated by the same entity. Enabling a user of cloud-based collaborative software development service 150 to activate a separate cloud-based service offers the advantage of providing to the user access to one or more additional software development-related services or functions not provided by cloud-based collaborative software development service 150, without the need to update cloud-based collaborative software development service 150. FIG. 5 is a flowchart of a method for providing online services in accordance with an embodiment.

Suppose, for example, that a user wishes to utilize a cloud-based service to compile the program code that is currently stored in program code file 400. The user accordingly employs user device 160-A to access cloud-based collaborative software development service 150, and accesses program code file 400. At step 510, access to program code file 400 is provided to user device 160-A. Browser 210 displays lines of code 431, 432, 433, 434, etc., in the manner described above.

Suppose now that the user further wishes to utilize a cloud-based online compiling service to compile the program code stored in program code file 400. Referring again to FIG. 4, the user right-clicks on a computer mouse (not shown) to view a menu 478 of options. Menu 478 includes a compile option 491 and a test option 493. In this example, the user selects compile option 491. Browser 210 transmits the user's selection of compile option 491 to cloud-based collaborative software development service 150.

In response to the user's selection, cloud-based service activation application 340 communicates with cloud-based service 180. At step 520, cloud-based service activation application 340 provides to cloud-based service 180 access to program code file 400 via network 105. Cloud-based service activation application 340 may provide to cloud-based service 180 file names, passwords, and other information necessary to access program code file 400, for example, or may provide more limited access.

In the illustrative embodiment, cloud-based service activation application 340 also transmits a request that cloud-based service 180 periodically compile the program code contained in program code file 400. In response, cloud-based service 180 accesses program code file 400 via network 105, and periodically compiles the program code stored therein. Methods for compiling program code are well-known. In other embodiments, cloud-based service 180 may perform a single compile operation, or perform multiple compile operations at user-defined intervals, or at other times.

At step 530, cloud-based collaborative software development service 150 provides to user device 160 information concerning a function that has been performed by cloud-based service 180 with respect to the program code. In the illustrative embodiment, cloud-based service 180 transmits status information indicating the status of one or more compile operations to cloud-based collaborative software development service 150, and cloud-based collaborative software development service 150 transmits the status information to user device 160. In other embodiments, cloud-based service 180 may transmit status information directly to user device 160.

Cloud-based collaborative software development service 150 may also transmit a request that browser 210 display the status information. In response, browser 210 displays the status information on display 270. Referring to FIG. 6, browser 210 may display program code file 400 in window 407 and simultaneously display status information relating to a compile operation in a second window 650 displayed in a selected region of display 270.

In another embodiment, cloud-based service 180 provides a program code testing service. A user may accordingly activate cloud-based service 180 to test the program code that is currently stored in program code file 400.

In an illustrative embodiment, the user employs user device 160-A to access cloud-based collaborative software development service 150, and accesses program code file 400. Access to program code file 400 is provided to user device 160-A (step 510). Browser 210 displays lines of code 431, 432, 433, 434, etc., in the manner described above.

Wishing to utilize cloud-based service 180 to periodically test the program code stored in program code file 400, the user right-clicks on the computer mouse (not shown) to view menu 478 of options (shown in FIG. 4). In this example, the user selects test option 493. Browser 210 transmits the user's selection of test option 493 to cloud-based collaborative software development service 150.

In response to the user's selection, cloud-based collaborative software development service 150 communicates with cloud-based service 180. Cloud-based collaborative software development service 150 provides to cloud-based service 180 access to program code file 400 (step 520).

Cloud-based collaborative software development service 150 also transmits a request that cloud-based service 180 periodically test the program code contained in program code file 400. In response, cloud-based service 180 accesses program code file 400 via network 105, and periodically tests the program code stored therein. Methods for testing program code are well-known.

Cloud-based collaborative software development service 150 provides to user device 160 information concerning the status of one or more test operations that have been performed (step 530). In the illustrative embodiment, cloud-based service 180 transmits status information indicating the status of one or more test operations to cloud-based collaborative software development service 150, and cloud-based collaborative software development service 150 transmits the status information to user device 160. Cloud-based collaborative software development service 150 may also transmit a request that browser 210 display the status information, or a representation of the status information. In response, browser 210 displays the status information on display 270. Referring now to FIG. 7, browser 210 may display program code file 400 in window 407 and simultaneously display status information relating to a testing operation in a second window 750 displayed in a selected region of display 270.

In other embodiments, cloud-based service 180 may provide other types of services, such as a code similarity identification service, a code review service, a lint checking service, a comment review service, etc.

In various embodiments, the method steps described herein, including the method steps described in FIG. 5, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 5. Certain steps of the methods described herein, including one or more of the steps of FIG. 5, may be performed by a server or by another processor in a network-based cloud-computing system. Certain steps of the methods described herein, including one or more of the steps of FIG. 5, may be performed by a client computer in a network-based cloud computing system. The steps of the methods described herein, including one or more of the steps of FIG. 5, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 8. Computer 800 comprises a processor 801 operatively coupled to a data storage device 802 and a memory 803. Processor 801 controls the overall operation of computer 800 by executing computer program instructions that define such operations. The computer program instructions may be stored in data storage device 802, or other computer readable medium, and loaded into memory 803 when execution of the computer program instructions is desired. Thus, the method steps of FIG. 5 can be defined by the computer program instructions stored in memory 803 and/or data storage device 802 and controlled by the processor 801 executing the computer program instructions. For example, the computer program instructions can be implemented as computer executable code programmed by one skilled in the art to perform an algorithm defined by the method steps of FIG. 5. Accordingly, by executing the computer program instructions, the processor 801 executes an algorithm defined by the method steps of FIG. 5. Computer 800 also includes one or more network interfaces 804 for communicating with other devices via a network. Computer 800 also includes one or more input/output devices 805 that enable user interaction with computer 800 (e.g., display, keyboard, mouse, speakers, buttons, etc.).

Processor 801 may include both general and special purpose microprocessors, and may be the sole processor or one of multiple processors of computer 800. Processor 801 may comprise one or more central processing units (CPUs), for example. Processor 801, data storage device 802, and/or memory 803 may include, be supplemented by, or incorporated in, one or more application-specific integrated circuits (ASICs) and/or one or more field programmable gate arrays (FPGAs).

Data storage device 802 and memory 803 each comprise a tangible non-transitory computer readable storage medium. Data storage device 802, and memory 803, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 805 may include peripherals, such as a printer, scanner, display screen, etc. For example, input/output devices 805 may include a display device such as a cathode ray tube (CRT) or liquid crystal display (LCD) monitor for displaying information to the user, a keyboard, and a pointing device such as a mouse or a trackball by which the user can provide input to computer 800.

Any or all of the systems and apparatus discussed herein, including online cloud-based collaborative software development service 150, cloud-based service 180, user device 160, and components thereof, including web browser 210, display 270, program code development service 310, and program code file repository 325, may be implemented using a computer such as computer 800.

One skilled in the art will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing online services, the method comprising:
providing to a first user at a first user device and a second user at a second user device simultaneous access to program code maintained by a first online service, wherein:
the first online service is capable of performing a set of software development functions without communicating with an external service, wherein the set of software development functions includes at least one of code building and debugging;
using the first online service to provide to a second online service access to the program code by using a service activation application within the first online service to activate the second online service, wherein the second online service provides a first software development function in addition to the set of software development functions provided by the first online service; and
providing to the first user device and the second user device information concerning the first software development function performed by the second online service with respect to the program code.

2. The method of claim 1, further comprising:
receiving from the first user device or the second user device a selection of the second online service; and
providing, via the first online service to the second online service, access to the program code in response to the selection.

3. The method of claim 2, wherein the first online service comprises a cloud-based collaborative software development service.

4. The method of claim 1, further comprising:
updating the program code based on data received from the first user device and the second user device.

5. (canceled)

6. The method of claim 1, wherein the second online service comprises one of a code similarity identification service, a code review service, a lint checking service, a comment review service, an automatic code generation service, a code editing service, a code analysis service, an error detection and correction service, a debugging service, a code building service, a code deployment service, a code execution service, a code searching service, and a version control service.

7. The method of claim 1, wherein:
the second online service comprises a compiling service; and
the first software development function comprises periodically compiling the program code.

8. The method of claim 1, wherein:
the second online service comprises a testing service; and
the first software development function comprises periodically testing the program code.

9. The method of claim 1, wherein:
the first online service resides and operates on a first server connected to the network; and
the second online service resides and operates on a second server connected to the network, wherein the second server is different from the first server.

10. The method of claim 1, further comprising:
receiving the information from the second online service, by the first online service, wherein the first online service provides the information to the first user device and the second user device.

11. A system for providing online services, the system comprising:
a memory configured to store program code that is maintained by a first online service; and
a processor configured to:
provide to a first user at a first user device and a second user at a second user device simultaneous access to the program code stored in the memory;
provide to the first user device and the second user device a set of software development functions from the first online service that is capable of performing the set of software development functions without communicating with an external service, wherein the set of software development functions includes at least one of code building and debugging;
use the first online service to provide to a second online service access to the stored program code by using a service activation application within the first online service to activate the second online service, wherein the second online service provides a first software development function in addition to the set of software development functions; and
provide to the first user device and the second user device information concerning the software development function performed by the second online service with respect to the program code.

12. The system of claim 11, wherein the processor is further configured to:
receive from the first user device or the second user device a selection of the second online service; and
provide, via the first online service to the second online service, access to the stored program code in response to the selection.

13. The system of claim 12, wherein the processor is further configured to:
update the stored program code based on data received from the user device.

14. (canceled)

15. The system of claim 11, wherein the second online service comprises one of a compiling service, a testing service, a code similarity identification service, a code review service, a lint checking service, a comment review service, an automatic code generation service, a code editing service, a code analysis service, an error detection and correction service, a debugging service, a code building service, a code deployment service, a code execution service, a code searching service, and a version control service.

16. A non-transitory computer readable medium having program instructions stored thereon, the instructions capable of execution by a processor and defining the steps of:
providing to a first user at a first user device and a second user at a second user device simultaneous access to program code maintained by a first online service, wherein the first online service is capable of performing a set of software development functions without communicating with an external service, wherein the set of software development functions includes at least one of code building and debugging;
using the first online service to provide to a second online service access to the program code by using a service activation application within the first online service to activate the second online service, wherein the second online service provides a first software development function in addition to the set of software development functions provided by the first online service; and
providing to the first user device and the second user device information concerning the software development function performed by the second online service with respect to the program code.

17. The non-transitory computer readable medium of claim 16, further comprising instructions defining the steps of:
receiving from the first user device or the second user device a selection of the second online service; and
providing, via the first online service to the second online service, access to the program code in response to the selection.

18. The non-transitory computer readable medium of claim 17, wherein the first online service comprises a cloud-based collaborative software development service.

19. A user device for a first user to access online services, the user device comprising:
a display screen; and
a processor configured to display a graphical user interface on the display screen, wherein the graphical user interface comprises:
a region for displaying a representation of program code maintained at a first online service, wherein the first online service is capable of performing a set of software development functions without communicating with an external service, wherein the set of software development functions includes at least one of code building and debugging, and the program code is provided to a second user at another user device; and
an option for activating a second online service, wherein
the second online service provides a first software development function in addition to the set of software development functions provided by the first online service; and
a selection of the option initiates using the first online service to provide access to the program code to the second online service by using a service activation application within the first online service to activate the second online service, and a display of information concerning the software development function performed by the second online service with respect to the program code.

20. The user device of claim 19, wherein the graphical user interface further comprises a second region for displaying the information.

21. The user device of claim 19, wherein the second online service comprises one of a compiling service, a testing service, a code similarity identification service, a code review service, a lint checking service, a comment review service, an automatic code generation service, a code editing service, a code analysis service, an error detection and correction service, a debugging service, a code building service, a code deployment service, a code execution service, a code searching service, and a version control service.
